(19) United States
(12) Patent Application Publication
(10) Pub. No.: US 2009/0015833 A1
(43) Pub. Date: Jan. 15, 2009

(54) DEVICE AND METHOD FOR IMPROVING THE MEASUREMENT ACCURACY IN AN OPTICAL CD MEASUREMENT SYSTEM

(75) Inventors: Michael Heiden, Wolfersheim (DE); Walter Steinberg, Weilmunster-Mottau (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Weilburg (DE)

(21) Appl. No.: 12/127,386

(22) Filed: May 27, 2008

(30) Foreign Application Priority Data
Jul. 11, 2007 (DE) 10 2007 032 626.4

(51) Int. Cl. G01J 4/00; G01B 11/14

(52) U.S. Cl. 356/364; 356/625

(57) ABSTRACT

A method and a device are disclosed, with which an improvement of the measurement accuracy for the determination of structure data is possible. There is provided a device having a support table (4) movable in the X-coordinate direction and the Y-coordinate direction, on which an additional holder (6) for holding a substrate (2) is carried, having at least one light source (16; 20), at least one objective (8) and a first detector unit (15a) receiving the light transmitted or reflected by structures applied to the substrate (2). There is further provided a polarization means (30a; 30b) associated with the light source (16; 20) and/or located in an optical imaging path (10; 12).

### RELATED APPLICATIONS

This application claims priority to German Patent Application No. 10 2007 032 626.4, filed on Jul. 11, 2007, which is incorporated herein by reference in its entirety.

### FIELD OF THE INVENTION

The present invention relates to a device and a method for improving the measurement accuracy for the determination of structure data, wherein the linearity limit is improved towards smaller structures in accordance with the invention.

### BACKGROUND OF THE INVENTION

The measurement of structure dimensions (so-called CD Critical Dimension) is normally performed with known systems, such as microscopes, CD-SEM, AFM, etc. So-called scatterometry methods are also based on measuring methods using microscopes; however, they generally require repetitive structures in the measurement field.

In principle, there are two kinds of samples on which the measurement is performed. On the one hand, there are masks (quartz disks) and on the other hand wafers (silicon disks). The structures on the wafers are generally four times smaller than those on the masks. The dimensions given in the following relate to masks.

The measurement structures generally have a rectangular structure (for example single lines, line fields; so-called line and space, L&S) with regular, equidistant or also irregular pitches, characterized by great lengths (several micrometers) and small widths (some hundred nanometers). Angles and so-called dots and holes (D&H), also called vias, which only have a size of some hundred nanometers in both dimensions, are also measured.

One major disadvantage of measuring with optical systems is the resolution limitation by diffractions. The result is, for example, that single lines are rendered much broader in the images or can hardly or no longer be distinguished from adjacent structures.

Furthermore, the measurement profiles acquired for determining the structure dimensions are subject to great variations due to the differences in the measurement set-up associated with the various known acquisition methods incident light (reflection) and transmitted light (transmission) as well as the different measured samples themselves (phase shift masks for different exposure wavelengths; 193 nm with argonfluoride lasers—ArF; 248 nm with kryptonfluoride lasers—KrF; chromium on quartz masks—CoG; resist masks).

The method of so-called edge detection has been found to be a stable method with very good measurement repeatability for determining the CD, because it remains relatively unaffected by small intensity variations of the illumination. The edge detection is based on the determination of a level of 100% of the measured profile and the position of the two profile edges. The method is disclosed, for example, in DE 100 47 211 A1.

Due to the lack of adequate calibration standards, the measurement values are not sufficiently accurate as absolute measurement values. The calibration is generally performed by means of a so-called pitch structure describing a line and a space of an equidistant line field. The width of the currently common pitch structure is in the range between about 1 and 4 micrometers. A pitch structure may be measured in a reproducible way, because the same edges are used for determining the pitch width.

Improvements regarding resolution (higher aperture) and/or optics and illumination as well as measurement stability allow very good repeatabilities (for example in the range of less than 1 nm with DUV optics for a wavelength at 248 nm) and a shift of the linearity limit towards smaller structures. The DUV optics is disclosed, for example, in DE 199 31 949 A1. A dry objective for microscopes suitable for DUV includes lens groups of fused silica, fluorspar and partially also lithium fluoride. It has a DUV focus for a wavelength band λ_{DUV}±Δλ, with Δλ=8 nm, and additionally a parfocal IR focus for an IR wavelength λ_{IR} with 760 nm≦λ_{IR}≦920 nm. For this purpose, the penultimate element is formed to be concave on both sides and its outer radius on the object side is significantly smaller than the outer radius on the image side. The DUV objective is suitable for IR auto-focus.

Prior art methods regarding linearity increase and/or optical proximity correction are described, for example, in the patent applications WO 01/92818 A1 and DE 102 57 323 A1. They disclose a method and a microscope for detecting images of an object, particularly for determining the location of an object with respect to a reference point, wherein the object is illuminated with a light source and is imaged onto a detector preferably implemented as a CCD camera with the help of an imaging system. The detected image of the object is compared to a reference image, wherein information on the properties of the imaging system is taken into account for minimizing the errors in the measurement value interpretation for the generation the reference image. In addition, in the case of a presettable deviation of the compared images the reference image is varied such that it corresponds at least largely to the detected image.

A further device and a method for improving the measurement accuracy are described in DE 10 2005 025 535 A1. The content of this application is incorporated in its entirety in the present application.

A disadvantage of the described systems is that the CD linearity is limited due to the standard optics used. Linear measurement is thus limited towards smaller structure widths.

### SUMMARY OF THE INVENTION

It is therefore an object of the present invention to provide a device with which a further improvement in increasing the linearity and thus the accuracy of the measurement of structures close to the optical resolution limit is achieved.

This object is achieved by a device including a support table movable in the X-coordinate direction and the Y-coordinate direction, an additional holder for holding a substrate is carried by the support table, at least one light source, at least one objective, a first detector unit receiving the light transmitted or reflected by structures on the substrate, and a polarization means associated with the light source and/or located in an optical imaging beam path.

It is further an object of the invention to provide a method for determining dimension measurement values (for example structure widths) with the help of an optical system, wherein the improvement consists in increasing the linearity and thus the accuracy of the measurement of structures close to the resolution limit.

This further object is achieved by a method comprising the steps of: illuminating a substrate with polarized light with essentially two polarization planes which are set according to the orientation of the structures on the mask.

The advantage consists in the increased competitiveness with respect to non-optical systems and systems as they are described, for example, in DE 10 2005 025 535 A1.

The device for improving the measurement accuracy for the determination of structure data is provided with a support table movable in the X-coordinate direction and in the Y-coordinate direction. An additional holder for holding a substrate is attached to the support table. There are provided at least one light source and at least one objective and a first detector unit receiving the light transmitted or reflected by structures applied to the substrate. There is provided a second detector which, at the same time, records the illumination intensity from the at least one light source and supplies it to a computer determining the structure data from the light received by the first detector unit and the second detector.

On the basis of theoretical calculations, it can be shown that the use of polarized light results in an improved linearity limit shifted towards smaller measurement structures.

The use of S-polarized light in the optical illumination path results in an improvement of the CD linearity for structures in the Y-direction. The use of P-polarized light, on the other hand, results in an improvement of the CD-linearity for structures in the X-direction.

By using polarized light, a significant shift of the linearity limit by several nanometers may be achieved depending on the objective used. For example, the linearity limit is shifted by 75 nm from 350 nm (unpolarized light) to 275 nm (polarized light) when using a DUV-ATM objective (150×/0.90/248 nm).

The polarization filters used are functionally inserted or integrated in the optical illumination path. According to a preferred embodiment, a rotatable polarization filter is used, which allows realizing a very compact construction. Depending on the orientation set, this rotatable filter permits improved linearity for the structure to be measured. However, when using a rotatable polarization filter, only one orientation of the structures may be measured per measurement run. This would require more time, because a separate measurement has to be performed for the measurements in the X and Y directions. The throughput would approximately be halved.

In order to avoid this problem, a Pockels or Kerr cell is used in the optical illumination path according to a further embodiment of the invention. By using an electro-optical switch in the form of a Pockels cell, the light source used may be switched in a minimum amount of time and/or the light intensity may be modulated. The use of the electro-optical effect thus allows switching the polarization direction within a few micro-seconds. Thus the polarization direction may be switched nearly without any delay and vibration between two camera images to be acquired.

With the help of the Pockels or Kerr cell, it is thus possible to alternately acquire images with S and P polarized light in one measurement run. Then a separate evaluation of the S and P polarization and thus the Y and X measurement structures may be performed.

As part of a normal measurement, about 100 images are captured in a Z-spacing of 13 nm and analyzed. If the alternating polarization described above is used, this yields about 50 images for S-polarization and about 50 images for P-polarization which are interlocked with each other in the Z-plane. In order to conduct measurements without a loss of information, the so-called Z-stage speed has to be adapted accordingly.

Optionally, at least a second detector unit for detecting an illumination intensity may be provided. This second detector unit may be arranged above the measurement table in an incident light arrangement and/or below the measurement table in a transmitted light arrangement.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1a shows a schematic view of a first variant of a set-up with which optical CD measurements are performed;

FIG. 1b shows a schematic view of a second variant of a set-up with which optical CD measurements are performed;

FIG. 2 shows a schematic view of a substrate with structures located thereon; and

FIG. 3 shows the comparison of determined CD measurement values for structures in the Y-direction in a diagram.

### DETAILED DESCRIPTION OF THE PREFERRED EMBODIMENTS

In the figures, identical reference numerals refer to elements or functional groups that are identical or have essentially the same effect.

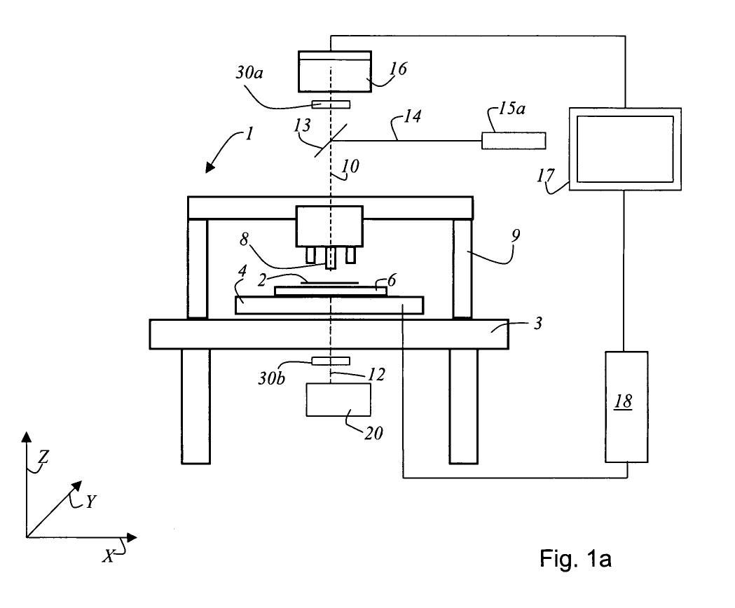

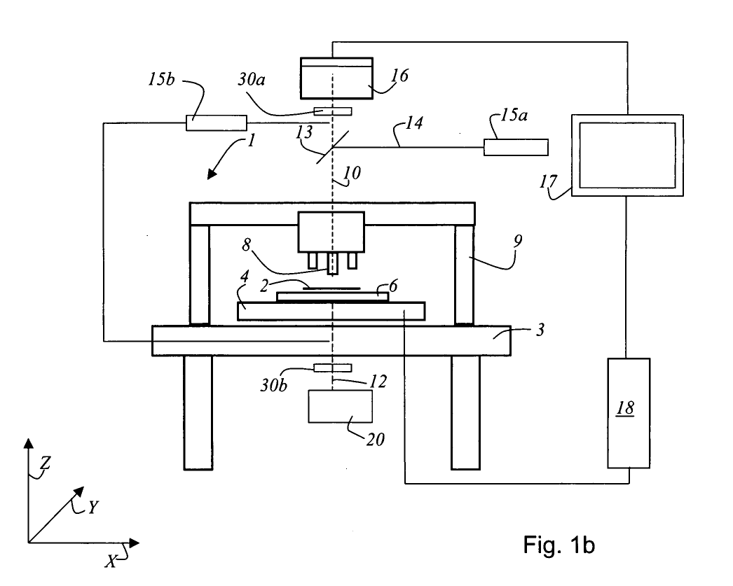

FIG. 1a shows the set-up 1 with which CD measurements may be performed on a microscopic element 2. A support table 4 for the substrate 2 is provided on a basic frame 3. The support table 4 is implemented as a so-called scanning table. The support table 4 is movable in an X-coordinate direction and in a Y-coordinate direction. The substrate 2 to be examined is deposited on the support table 4. The substrate 2 may be held in an additional holder 6 on the support table 4. The substrate 2 is a wafer, a mask, a micromechanical element or a related element. For the imaging of the substrate 2, at least one objective 8 is provided which defines an optical imaging path 10. The support table 4 and the additional holder 6 are designed such that they are also suitable for transmitted light illumination. For this purpose, the support table 4 and the additional holder 6 are formed with a recess (not shown) letting pass the transmitted light illumination 12. The transmitted light illumination 12 originates from a light source 20 below the basic frame 3 and the table 4. The incident light illumination originates from a light source 16 above the table 4. In the optical imaging path 10, there is provided a beam splitter 13 directing the detection light 14 to a first detection unit 15a. The first detection unit 15a is provided downstream with respect to the beam splitter 13 in the optical imaging path 10. There may also be provided a CCD camera with which the image of the location to be examined on the substrate 2 is recorded or captured. The detection unit 15a is connected to a display 17 and a computer 18. The computer 18 serves for controlling the device 1, for processing the acquired data and for storing and evaluating the acquired data.

An extension of the device set-up shown in FIG. 1a is that a second detector 15b is provided which is used for simultaneously recording the illumination intensity (cf. FIG. 1b). Known optical means are provided that direct the light correspondingly to the second detector 15b. Non-critical reference structures are recorded in the same way simultaneously or with a delay, advantageously, for example, by a CCD camera.

Although, in the representation of FIG. 1b, the additional second detector 15b is only shown in an incident light arrangement, this is not to be considered as limiting in any way. Such an additional optical detector 15b may optionally also be arranged below the support table 4, which corresponds to a transmitted light arrangement.

In the embodiment shown, the several objectives 8 are provided on a revolver (not shown), so that a user may select various magnifications. The support table 4 is designed to be movable in an X-coordinate direction and a Y-coordinate direction, which are perpendicular to each other. Thus any location to be observed on the substrate 2 may be brought into the optical imaging path 10.

The polarization filter 30a, 30b used according to the invention is integrated in the optical illumination path. When measuring by means of incident light illumination, the polarization filter 30a is mounted between the incident light source 16 and the beam splitter 13. When measuring by means of transmitted light illumination, the polarization filter 30b is mounted between the transmitted light source 20 and the support table 4 with the substrate 2.

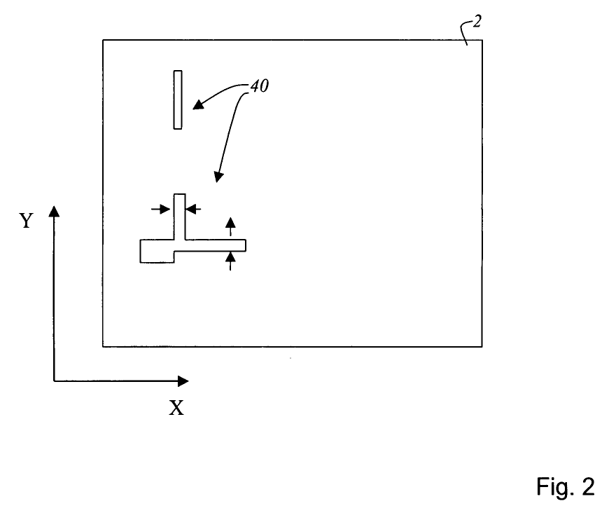

The schematic representation of FIG. 2 shows a top view of a microscopic element and examples of conducting structures 40 applied thereto, which exhibit essentially linear courses in directions orthogonal to each other. By using an inventive device, smaller structures than previously possible may be optically measured.

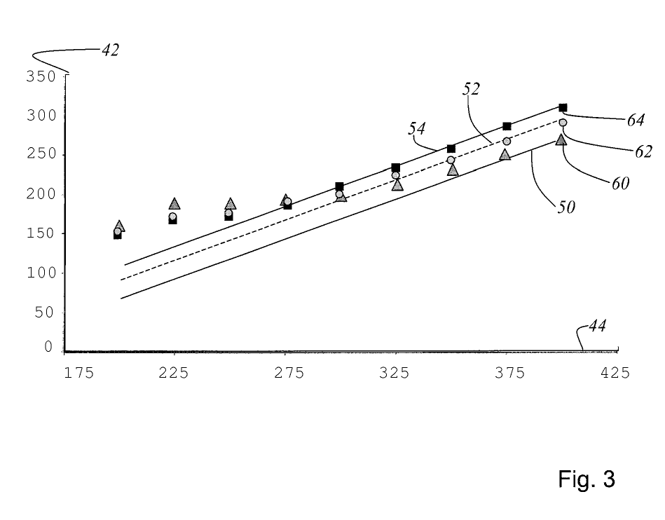

FIG. 3 shows the comparison of determined CD measurement values for structures in the Y-direction in a diagram. It shows that an S-polarization results in an improved linearity limit for Y-structures. The CD linearity is illustrated by a 248 nm illumination. Numerical values for the optical CD between about 50 nm and about 250 nm are plotted on the vertical axis 42. Numerical values for the nominal CD between about 200 nm and about 400 nm are plotted on the horizontal axis 44. The three lines 50, 52 and 54 indicate linearities, wherein the lower line 50 represents a linearity for light polarized in parallel (P-polarization), the middle line 52 represents a linearity for non-polarized light, and the upper line 54 represents a linearity for perpendicularly polarized light (S-polarization). Correspondingly, the triangular measurement points 60 show measurement values acquired with a P-polarization. The round measurement points 62 show measurement values acquired without any polarization direction. The square measurement points 64 show measurement values acquired with an S-polarization.

The diagram shows that, with unpolarized light, deviations occur already at about 350 nm, so that this area represents the approximate linearity limit. With S-polarized light, however, the structures may be detected up to about 275 nm without linearity deviations. This means that, for the DUV-ATM objective used (150×/0.90/248 nm), the linearity limit may be shifted as compared to unpolarized light from about 350 nm to about 275 nm.

The use of a Pockels or Kerr cell as polarization filter in the optical illumination path permits very fast switching of the polarization direction and thus measurement runs in currently known clock periods without prolonging the time periods needed for the optical element inspections by the additional polarization in the optical illumination path. By means of the electro-optical effect, it is possible to switch between the various polarization directions within a few micro-seconds, so that images may be acquired alternately with S and P polarization and separate evaluations for S and P polarization directions or for the X and Y measurement structures may be performed.

While this invention has been particularly shown and described with references to preferred embodiments thereof, it will be understood by those skilled in the art that various changes in form and details may be made therein without departing from the scope of the invention encompassed by the appended claims.

What is claimed is:

1. A device for improving measurement accuracy for the determination of geometrical structure data comprising: a support table movable in the X-coordinate direction and the Y-coordinate direction, an additional holder for holding a substrate is carried by the support table, at least one light source, at least one objective, a first detector unit receiving the light transmitted or reflected by structures on the substrate, and a polarization means associated with the light source and/or located in an optical imaging beam path.

2. The device of claim 1, wherein the polarization means having two polarization planes in the X and Y coordinate directions that are settable to be orthogonal to each other.

3. The device of claim 1, wherein the polarization means is a rotatable polarization filter.

4. The device of claim 1, wherein the polarization means is a switchable polarization means.

5. The device of claim 4, wherein the switchable polarization means comprises an electronic drive for cooperation with an electro-optical effect.

6. The device of claim 5, wherein the switchable polarization means is a Pockels and/or Kerr cell in the optical illumination beam path.

7. The device of claim 1, wherein at least a second detector unit is provided for detecting an illumination intensity.

8. The device of claim 7, wherein the second detector unit is arranged above the measurement table in an incident light arrangement and/or below the measurement table in a transmitted light arrangement.

9. A method for improving the measurement accuracy for the determination of geometrical structure data, comprises the steps of illuminating a substrate with polarized light with essentially two polarization planes which are set according to the orientation of the structures on the mask.

10. The method of claim 9, wherein the change of polarization direction by the rotation is possible.

11. The method of claim 9, wherein a switch of the polarization direction is possible.

12. The method of claim 11, wherein an electro-optical effect is used for switching the polarization direction.

13. The method of claim 12, wherein the alternation of the polarization direction is carried out during a measurement run.
